(19) United States
(12) Patent Application Publication
(10) Pub. No.: US 2007/0171460 A1
(43) Pub. Date: Jul. 26, 2007

(54) Photo duplexing method

(75) Inventor: Daniel Paul Cahill, Verona, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/338,451

(22) Filed: Jan. 24, 2006

(51) Int. Cl. G06F 3/12

(52) U.S. Cl. 358/1.15; 358/1.8

(57) ABSTRACT

An improved printing system is provided for printing digital camera images on the front side of a sheet of print media, and then printing a silhouette on the reverse side of the same sheet. The reverse side will also have identification information printed thereon, so that the outlines (silhouette) of certain objects can be easily identified. The outline shapes on the reverse side will correspond to the digital image on the front side; they are not a mirror image.

### TECHNICAL FIELD

The present invention relates generally to image forming equipment and is particularly directed to printers of the type that can print digital images. The invention is specifically disclosed as a method for printing a digital image received from a digital camera, or a cell phone with an imaging sensor, and generating a second “outline” image that comprises multiple lines (or curves) that may have the appearance of a silhouette of certain elements or objects that are contained in the initial digital image data. Identification information is also generated that corresponds to the various objects (or silhouette shapes) that make up the second image. The digital image is printed on a first (or front) side. of a sheet of print media; the second image comprising both the outline (or silhouette) data and the identification information is printed on a second, opposite (or reverse) side of the same sheet of print media. The second image is consistent in appearance with the initial digital image taken by the digital camera; in other words, the second image is not a mirror image of the initial digital image. The front and back sides of the sheet of print media can be both printed automatically if the printer contains a duplexer; otherwise, human intervention can take the sheet, after being printed on its front side, and place the sheet in the input area of the printer upside-down, so the back side can then be printed with the outline data and identification information.

### BACKGROUND OF THE INVENTION

There have been conventional printers that can print on both sides of a sheet of print media, in which certain alphanumeric data is printed on the reverse side of a print, and in which the front side has photographic or image data. Some of the conventional systems are used for printing digital photographs, and many times the alphanumeric data identifies the photo processing lab, or the date that the photo processing lab processed the film and made the prints. Some of this information includes an order number, and reorder information that will be useful to the user after he or she receives the prints back from the photo processing lab. Some of the conventional systems can include special user information, which could include a special message, such as a birthday message. However, this type of message is not included with any type of image information on the reverse side of the photograph print.

Another conventional system will automatically locate dark areas of image density on the front surface of a photographic print, and then will print text on the reverse surface specifically in the areas of the dark image density, so that the reverse-printed text information will not be visible when viewing the photograph from the front side of the print.

Another conventional feature is where certain digital cameras have a Screen Assist function that shows a silhouette of certain image information in the viewfinder, after an image has been acquired. This Screen Assist data is not necessarily printed later, but can help a user determine if the type of image to be taken is desirable.

### SUMMARY OF THE INVENTION

Accordingly, it is an advantage of the present invention to print a digital image on the front surface of a sheet of print media, and then also to print a set of image outlines such as a silhouette on the reverse side of that same sheet of print media, in which the image outlines correspond to certain objects that are printed on the front side.

It is another advantage of the present invention to print a digital image on the front side of a sheet of print media and, on the reverse side of the same sheet of print media, to print silhouette information that corresponds to objects on the front digital image, and also to print identifying information (or “identification information”) that is positioned so that the identifying information corresponds to the silhouette information.

It is a further advantage of the present invention to provide a printer that can accept digital image information from a digital-acquiring source and print that digital image information on the front side of a sheet of print media, then either acquire or generate image outlines that correspond to certain objects contained in the original digital image and print those outlines on the reverse side of the same sheet of print media, and further to print identifying text information at locations determined by a user, so that the text information will correlate with the image outlines on the reverse side of the sheet of print media.

It is yet another advantage of the present invention to provide a method for acquiring digital image data and printing that digital image on the front side of a sheet of print media, and acquiring silhouette information of certain objects that are included in the digital image data, and also audible information that corresponds to identifying information of that same digital image, and printing the silhouette data and audible information in one form or another, on the reverse side of the same sheet of print media.

Additional advantages and other novel features of the invention will be set forth in part in the description that follows and in part will become apparent to those skilled in the art upon examination of the following or may be learned with the practice of the invention.

To achieve the foregoing and other advantages, and in accordance with one aspect of the present invention, a method for controlling a printing apparatus is provided, in which the method comprises the following steps: (a) receiving a print job from an external device, the print job containing digital image data; (b) configuring at least a portion of the digital image data as front-side image data, and printing the front-side image data on a first surface of a sheet of print media; (c) determining outline image information from the front-side image data; (d) determining identification information that corresponds to at least a portion of the outline image information; (e) determining at least one position where the identification information is to be located with respect to the outline image information; and (f) configuring both the outline image information and the identification information as reverse-side image data, and printing the reverse-side image data on a second, opposite surface of the sheet of print media.

In accordance with another aspect of the present invention, a printing apparatus is provided, which comprises: an input/output circuit; an interface circuit; and a printing station that applies image-forming material to a sheet of print media; wherein: the input/output circuit receives a print job that contains digital image data; the interface circuit contains input and output devices that are configured to move a sheet of print media to the printing station and, according to the digital image data, to apply the image-forming material to a first surface of the sheet of print media; the input/output circuit receives outline image information that is based on the digital image data; the input/output circuit receives identification information that corresponds to the outline image information, and which determines at least one position where the identification information is to be located with respect to the outline image information; and the interface circuit is further configured to move the sheet of print media to the printing station a second time and, according to the outline image information and the identification information, to apply the image-forming material to a second, opposite surface of the sheet of print media.

In accordance with yet another aspect of the present invention, a printing apparatus is provided, which comprises: an input/output circuit; an interface circuit; a processing circuit that controls signals to and from the interface circuit; a memory circuit that stores data used by the processing circuit; and a printing station that applies image-forming material to a sheet of print media; wherein: (a) the input/output circuit receives a print job that contains digital image data; (b) the interface circuit contains input and output devices that are configured to move a sheet of print media to the printing station and, according to the digital image data, to apply the image-forming material to a first surface of the sheet of print media; (c) the processing circuit is configured to: (i) determine outline image information that is based on the digital image data; (ii) determine identification information that corresponds to the outline image information; and (iii) determine at least one position where the identification information is to be located with respect to the outline image information; and (d) the interface circuit is further configured to move the sheet of print media to the printing station a second time and, according to the outline image information and the identification information, to apply the image-forming material to a second, opposite surface of the sheet of print media.

Still other advantages of the present invention will become apparent to those skilled in this art from the following description and drawings wherein there is described and shown a preferred embodiment of this invention in one of the best modes contemplated for carrying out the invention. As will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the present invention, and together with the description and claims serve to explain the principles of the invention. In the drawings:

FIG. 1 is a block diagram of some of the major components used in a first embodiment of the present invention, including a digital camera, a computer, and a printer.

FIG. 2 is a block diagram of some of the major components used in a second embodiment of the present invention, including a digital camera, a cell phone, and a printer.

FIG. 3 is a depiction of a digital image taken by a digital imaging device, printed on the front side of a sheet of print media in the form of a digital photograph, as used in the present invention.

FIG. 4 is a view of the back side of the digital photograph of FIG. 3, showing image information and identification information provided by use of the present invention, which corresponds to certain aspects of the images on the front side.

FIG. 5 is a flow chart showing some of the logical operations used in the present invention.

FIG. 6 is a flow chart showing some other of the logical operations used in the present invention.

### DETAILED DESCRIPTION OF THE PREFERRED EMBODIMENT

Reference will now be made in detail to the present preferred embodiment of the invention, an example of which is illustrated in the accompanying drawings, wherein like numerals indicate the same elements throughout the views.

In the present invention, a digital imaging device (e.g., a digital camera) can be used to acquire a two-dimensional image of virtually any type of object, including photographs of people, animals, man-made objects, and natural objects. Many photographs will have certain important features (such as the persons in the photograph) that much later will come to mind when the photographs are viewed. However, not every object (including persons) will be well remembered by the viewer of the photograph; either the identity of the object will be unknown (or forgotten), or the date the photograph was taken will be unknown (or forgotten).

Many times a photograph is sent to a family member or a friend with the names (and/or dates) of the objects in the photograph (e.g., persons or places) written on the photograph, either on the front surface of the photograph, or on the back. Some Christmas cards are sent with a family portrait as the main feature of the card, and there will be signatures of the persons (or their printed names) along one expanded border of the card. The exact name may or may not easily match up to the location of a particular person in the photograph, and sometimes the viewer can be confused as to the exact identity of each of those persons.

If a silhouette of the important features is provided on a separate sheet, and if the name or other identifying information is provided to correspond to the silhouetted objects, then such confusion can be easily and simply overcome. Some books, including history books, will print a photograph of a group of people, and then show a silhouette on the opposite page that lists the names of some or all of the persons in the photograph.

In the present invention, image information is printed on the reverse (or back) side of a sheet of print media that also has digital image printed on the obverse (or front) side of the same sheet of print media. This reverse-side image information can be made in the form of a silhouette, and identifying information about the objects that have been silhouetted also can be printed on the reverse side in appropriate positions to be easily matched up to the silhouette image. In this manner, the viewer can first inspect the front side of the sheet of print media, then flip over to the back side of the same sheet to find out the identity of the object of interest (e.g., a person in the image).

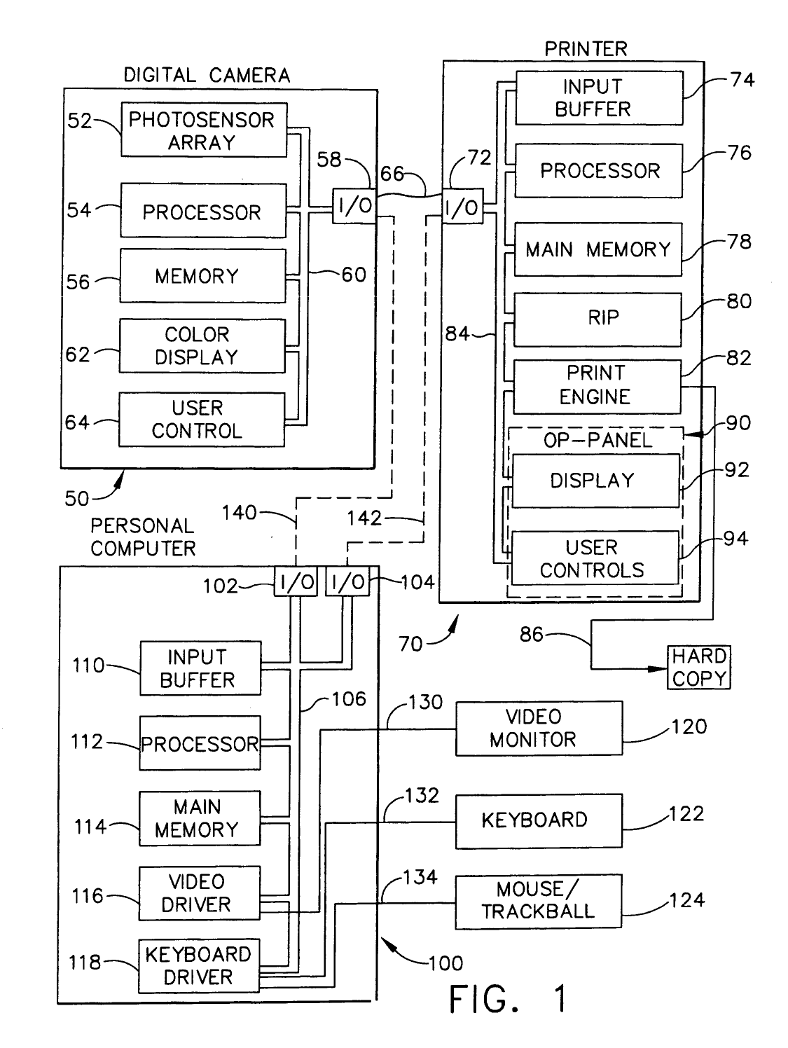

The present invention makes it possible to automatically extract certain image information from the originating image that appears on the front side of the sheet, and use that image information to generate a second image that is then printed on the back side of the same sheet. The second image (on the back side) can comprise a silhouette, if desired. The identifying information can be written text that is entered via a keyboard or a keypad, for example; or the identifying information could be originated as audio information that is received through a microphone, and then transcribed into text data, for example. Such originating audio information could also be stored and played back in other forms, if desired. Referring now to FIG. 1, a hardware block diagram is provided showing some of the major components that can be used in the present invention. A digital camera is generally designated by the reference numeral 50, and includes a photosensor array 52, a processing circuit 54, a memory circuit 56, and an input/output (I/O) circuit 58. These circuits are electrically connected together with some type of data or address lines, or command signal lines, and all of these electrical connections are generally designated by the reference numeral 60 in the form of a bus. Also connected to these processing and memory devices are a color display 62 and a set of user controls 64. Typical digital cameras have many user controls, to set the adjustment for wide angle or zoom lens effects, and for many other settings, including time exposure and focal length attributes in some cameras.

A second element of the present invention is a printer, generally designated by the reference numeral 70. Printer 70 has an input/output circuit 72, an input buffer 74, a processing circuit 76, and a memory circuit 78. In addition, many printers have a processing capability known as “raster image processing,” which is also referred to as a “RIP processor,” designated by the reference numeral 80 on FIG. 1. Most printers also have a print engine processing circuit, designated by the reference numeral 82 on FIG. 1. It will be understood that the RIP processor 80 and the print engine processor 82 can be separate processing devices, or they could perhaps be both in one larger processing circuit, which may also include the processor 76 on FIG. 1. Many printers use Application Specific Integrated Circuits (ASICs) to contain logic elements, input/output elements, memory elements, and even a processing circuit, all within one device. As ASICs become more powerful, the more likely that virtually all of the circuits described above will be contained in a single ASIC. On the other hand, many printers are designed with separate print engine circuitry, for ease of manufacture.

It will be understood that the input buffer 74 could be part of a larger main memory circuit, such as the memory 78. On the other hand, the input buffer 74 could be a separate, dedicated set of memory elements or buffers. Most or all of the main hardware elements could be connected to each other via a bus 84, containing data, address, and command lines.

After being printed, the printer 70 will output a sheet of print media to an output area, typically an output paper tray, or some type of output surface that is part of the printer's enclosure. An output pathway 86 directs the sheet of print media from the print engine 82 to this output area. For the present invention to function, both sides of the sheet media are to be printed; a duplexing-capable printer can automatically perform this function. However, a simpler printer (e.g., without a duplexer function), such as most ink jet printers, can print on both sides of the same sheet of print media with the intervention of a human user who takes the sheet media from the output area (after that sheet has been printed on one side), and places that same sheet media back into the input tray upside-down, so it can be fed back to the print engine (or printhead) a second time and thus be printed on its reverse side. (Note that the term “input tray” applies to any type of print media input device, whether it is a tray or merely a slanted surface, for example.)

It should be noted that the print engine 82 of FIG. 1 hints that printer 70 is a laser printer, since the printing station of a laser printer is usually referred to as such. However, the present invention works with many types of printers, including ink jet printers. In an ink jet printer, for example, the printing station is typically referred to as a printhead, not a print engine. For the purposes of this patent document, all references to a print engine will also encompass other types of printing station devices, including those that dispense toner, ink, wax, or other compounds or materials that could be. developed in the future. Moreover, the principles of the present invention apply both to monochrome printers and multi-color printers.

Most printers have some type of operator panel, which is generally designated by the reference numeral 90 on FIG. 1. In a typical printer, the op-panel 90 will include some type of display 92 and set of user controls 94. In many printers, the display 92 is a relatively inexpensive LCD device that has multiple rows and columns of alphanumeric characters. As displays become more powerful and less expensive, then a graphical display could be used on a printer, even including a display with full three-color capabilities. The user controls are typically a set of push buttons, and may include some type of pointing device, such as a cursor control, which could be particularly useful if the display 92 is a graphic display.

Another possible component for use in the present invention is a personal computer, generally designated by the reference numeral 100. The personal computer (“PC ”) 100 will typically include multiple input/output (I/O) circuits, including the circuits 102 and 104 on FIG. 1. The signals passing through the I/O circuits 102 and 104 will typically pass through a set of signal and command lines, which could also have address lines connected thereto. All of these data, address, and command lines could be grouped as a bus, such as the bus 106 on FIG. 1.

In PC 100, the I/O circuits are connected to an input buffer 110, which may be part of the system main memory, which is depicted at the reference numeral 114. A typical PC will have a microprocessor, depicted on FIG. 1 by a processing circuit 112. A typical PC will also have a video driver circuit 116 and a keyboard driver circuit 118. All of these devices are typically connected to one another by bus 106.

A typical PC will have a video monitor 120, a keyboard 122, and a pointing device 124, such as mouse or a trackball. Video monitor 120 is connected to the video driver circuit 116 over a signal line 130. Keyboard 122 is connected to the keyboard driver circuit 118 by a signal line 132. The mouse/trackball 124 is connected to some type of pointing driver circuit over a signal line 134. The mouse/trackball 124 may interface to a separate driver circuit, or perhaps to the keyboard driver circuit 118, particularly if the PC 100 is some type of portable device, such as a laptop or a palm pilot, for example. These are well-known interface circuits and hardware components.

It will be understood that the digital camera 50, printer 70, and personal computer 100 could have many more components than described above, or perhaps could be missing some of the circuits described above, while still falling within the principles of the present invention.

For the functions that are performed by the digital camera 50, the image data (and the identification data) could remain within the digital camera for the purposes of some users; however, many users will want to print or otherwise store this data on another device. Therefore, the digital camera I/O circuit 58 can be connected to a printer such as the printer 70, for example, through its I/O circuit 72 via a signal line 66. In this situation, the digital camera 50 will acquire the image and eventually transfer that image to the printer 70. Any image processing could take place in either of these devices, depending on where the main processing power and memory capabilities are located. On the other hand, a PC could be used to perform these processing intensive functions, and thus the digital camera I/O circuit 58 could be connected to the PC I/O circuit 102 via a signal line 140. Moreover, if the stored image is to be printed after the image processing takes on the PC 100, then the other I/O circuit 104 of the PC can be connected to the printer I/O circuit 72 via a signal line 142.

It will be understood that the image capture processing software of the present invention, including creating a silhouette and positioning the identifying information, can be designed to work on any of the three major systems described in FIG. 1, i.e., the digital camera 50, the printer 70, or the PC 100. In addition, some of the image processing could be distributed through more than one of these major components, although that would likely require more specialized software that would be compatible with a specific combination of these major systems. It will also be understood that the printer 70 will not necessarily need all of the processing circuits that are depicted on FIG. 1. For example, some of the processing for the RIP processor 80, and even for the print engine 82, could be performed on the PC 100, and the RIP processor 80 and print engine processor 82 would essentially become virtual processors with respect to the printer's hardware components. All of these options are contemplated in the present invention.

It should be noted that much of the control logic needed for controlling the functions of the printing process and the sheet media movements of a printer can be off-loaded to a physically separate processing circuit, or to a virtual processing device. For example, a host computer could send appropriate command signals directly to output switching devices (e.g., transistors or triacs) that reside on the printer main body; the host computer could also directly receive input signals from various sensors on the printer main body, to facilitate the control logic that is resident on such a host computer. Thus the control logic (or a portion thereof) of a printing device need not always be part of the physical printer, but may be resident in another physical device, or perhaps be virtual. In reference to FIG. 1, the processor 76 may not have to reside within the printer 70, but instead could be replaced by a set of electrical or optical command signal-carrying and data signal-carrying pathways (e.g., a set of parallel electrical conductors or fiber optic channels). The output switching devices and the various sensors (as input devices) can act essentially as an overall “interface circuit.” Such an interface circuit (as a signal conditioner, if nothing else) will typically be found in every modern printer, regardless of whether the printer's controller resides on the printer itself, or is resident on a computing device that is external to the printer body. All of these options are contemplated in the present invention.

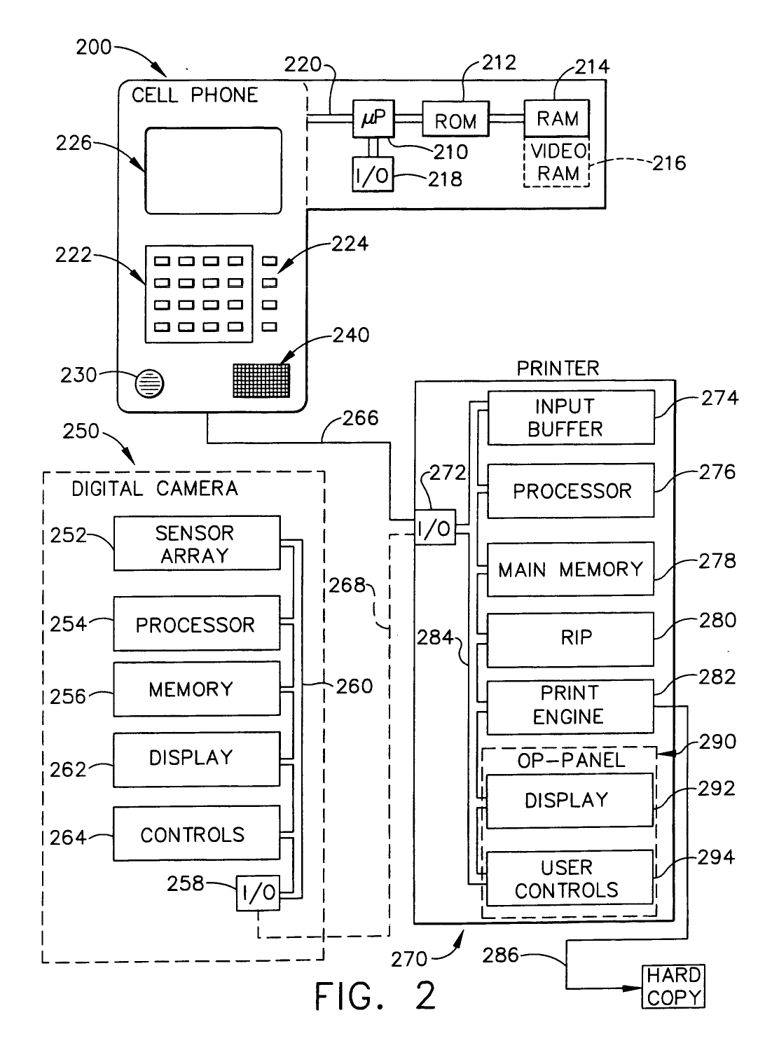

Referring now to FIG. 2, a printer is again depicted, this time generally designated by the reference numeral 270. Printer 270 would typically be a sheet printer, much like the printer 70 depicted on FIG. 1. Printer 270 has an input/output circuit 272, an input buffer 274, a processing circuit 276, a memory circuit 278, a “RIP processor” 280, and a print engine processing circuit 282. As in the printer 70 of FIG. 1, it will be understood that the RIP processor 280 and the print engine processor 282 can be separate processing devices, or they could perhaps be both in one larger processing circuit, which may also include the processor 276 on FIG. 2, or could be incorporated in an ASIC. The input buffer 274 could be part of a larger main memory circuit, such as the memory 278, or the input buffer 274 could be a separate, dedicated set of memory elements or buffers. Most or all of the main hardware elements could be connected to each other via a bus 284, containing data, address, and command lines.

After being printed, printer 270 will output a sheet of print media to an output area, typically an output paper tray, or some type of output surface that is part of the printer's enclosure. An output pathway 286 directs the sheet of print media from the print engine 282 to this output area. As discussed above, both sides of the sheet media are to be printed in the present invention, and a duplexing-capable printer can automatically perform this function, while a simpler printer (e.g., without a duplexer function) can print on both sides of the same sheet of print media with the intervention of a human user. As in printer 70 on FIG. 1, the “print engine” 282 will encompass not only electrophotographic print engines, but also printheads and other types of printing station devices, including those that dispense toner, ink, wax, or other compounds or materials that could be developed in the future. Printer 270 also has an operator panel 290, with a display 92 and set of user controls 294.

On FIG. 2, a digital camera is generally designated by the reference numeral 250, and includes a photosensor array 252, a processing circuit 254, a memory circuit 256, and an input/output (I/O) circuit 258. These circuits are electrically connected together with some type of data or address lines, or command signal lines, and all of these electrical connections are generally designated by the reference numeral 260 in the form of a bus. Also connected to these processing and memory devices are a color display 262 and a set of user controls 264. As noted above, typical digital cameras have many user controls, to set the adjustment for wide angle or zoom lens effects, and for. many other settings, including time exposure and focal length attributes in some cameras.

In FIG. 2, the digital camera 250 can be directly connected to the printer 270, by use of a communications link or data cable, generally designated by the reference numeral 268. This communications link will carry signals between the digital camera's input/output circuit 258 and the printer's input/output circuit 272. It should be noted that not every printer is capable of directly communicating with a digital camera. Moreover, not every digital camera is capable of communicating directly with a printer. The control software used by the processing circuits 254 and 276 will need to have appropriate interfacing to exchange data between these two devices.

In the present invention, the controls of one or both of these devices will be used to input identifying data, and also to control other aspects for back-printing on a sheet of print media that comes through the printer and arrives at the output pathway 286. For more efficient use in determining the reverse-side image data and identifying data, either the digital camera 250 or the printer 270 will likely need a display that will be viewable by the human user while entering identifying data using the controls. This may be more difficult to achieve at a typical digital camera than when viewing the display of a printer's op-panel. In any event, with the appropriate control software, either one of these devices could be used to determine silhouette features and identifying data (e.g., text information), and their locations on the reverse side of a sheet of print media.

A third device on FIG. 2 is a cell phone, generally designated by the reference numeral 200. Cell phone 200 would be an image-capable recording device, for use in the present invention. Once an image is acquired, the image data could be processed just as if that image had been acquired by a standard digital camera, for the purposes of the present invention.

Cell phone 200 has a processing circuit 210, a Read Only Memory (ROM) circuit 212, a Random Access Memory (RAM) circuit 214, which will typically include some type of video RAM at 216. The video RAM 216 could be dedicated memory elements, or it could be a portion of the overall cell phone's RAM circuit 214, with a certain portion allocated for use as the video RAM (which stores data for use in a display).

Cell phone 200 will include a keypad 222, which would typically include the numeric digits and other important buttons for use in making telephone calls. A separate set of user controls or pushbuttons is designated by the reference numeral 224, and these can be buttons for controlling other important functions, such as initiating a call or terminating a call, for example, or for controlling the acquired image data. A display 226 is included on the face of the picture cell phone 200, and such a display would typically be a color LCD-type display. Cell phone 200 also includes an audio sensor, such as a microphone 230. The cell phone will also require some type of optical imaging device, such as an array of optical sensors at 240, which typically would be an array of CCD semiconductors.

Cell phone 200 will also include some type of input/output circuit at 218. This I/O circuit can interface with the pushbuttons 222 and 224. Also, the I/O circuit 218 can be used to interface with the printer 270, and that would be a different type of interface, probably in the form of serial data. The communications link to the printer 270 may use a data cable 266, although this link could be a wireless link, if desired.

In a similar fashion to using a digital camera 250, the picture cell phone 200 could acquire an image using its optical sensor array 240, and could then temporarily store and transfer that image to the printer 270. Identifying data could be entered at the cell phone keypad 222, or it could be entered at the op-panel controls 294 of the printer 270. The creation of the image information that will be used on the reverse side of a sheet of print media could be controlled by the cell phone 200, although that would require special software that normally would not be found in a typical cell phone. Alternatively, creation of the image information for the reverse-printing on the sheet of print media could of course be controlled by the printer, via the op-panel 290.

It will be understood that the image-acquiring device used in the present invention is not limited to digital cameras or picture-taking telephones, although these are the types of devices depicted in FIGS. 1 and 2. Digital images can be acquired in many ways, and by several different types of devices using today's technology, not to mention tomorrow's possible technology. For example, a video camera that records images in a digital format can easily produce a digital “still” image, which could be directly incorporated as the initial image data used in the present invention. Analog video cameras record images as well, and somewhat more sophisticated video editing equipment could be used to generate a digital still image from this recorded image data, as well.

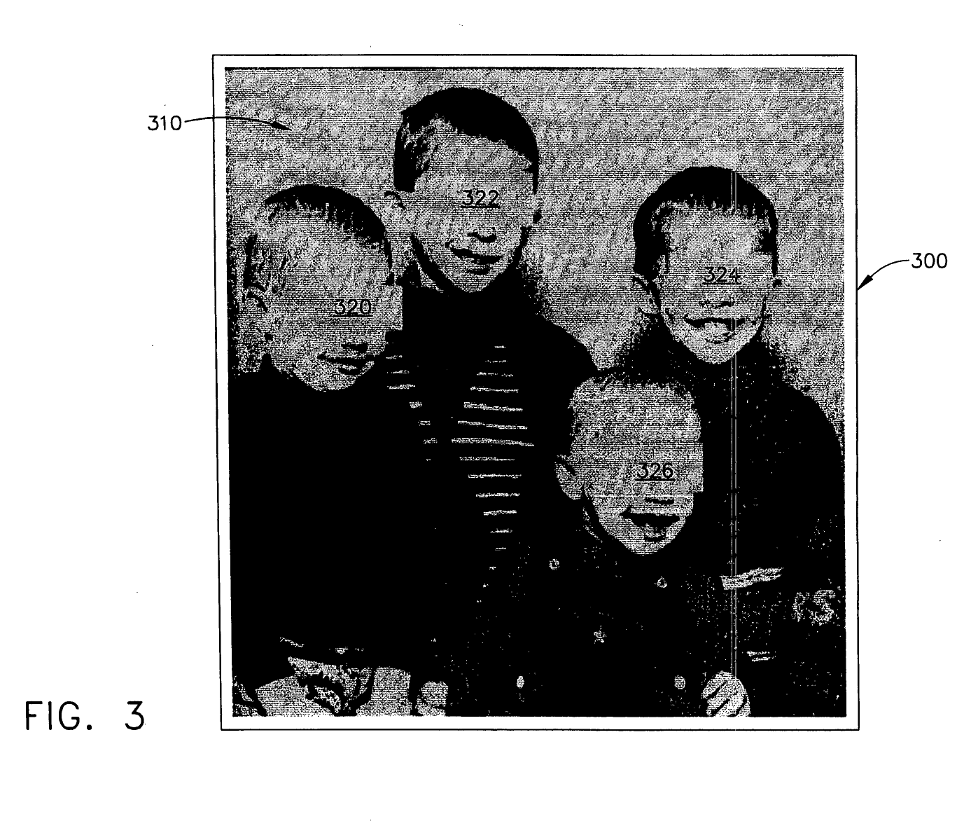

Referring now to FIG. 3, a sheet of print media is illustrated, generally depicted by the reference numeral 300. In FIG. 3, the front side of the sheet is viewed, and is generally designated by the reference numeral 310. In this front surface, a photographic image of four children is depicted, and each of these children is designated by a reference numeral, i.e., 320, 322, 324, or 326.

As can be seen in FIG. 3, the background portion of the image on the surface 310 is relatively plain, and the “main objects” on this front image 310 are the four children 320, 322, 324, and 326. If a person wanted to identify each of these children in the image 310, a silhouette could be drawn around each of the four children, and their names could be placed within the silhouette at an appropriate location. With regard to the present invention, such a silhouette must first be generated as image data that will be printed on the reverse side of this sheet of print media 300. Identifying data will then be added to the silhouette image information, as appropriate.

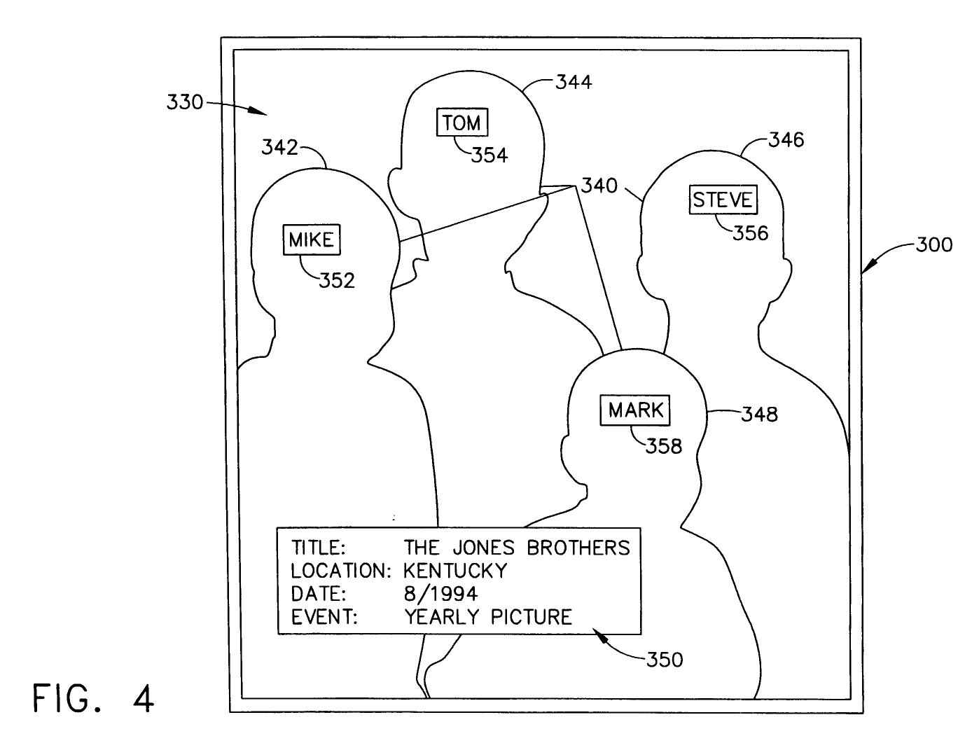

Referring now to FIG. 4, the same sheet of print media 300 is again depicted, this time showing the reverse side, generally designated by the reference numeral 330. In FIG. 4, a set of outline objects, mainly in the form of a silhouette, has been created as image data for each of the four children, and the overall silhouette is generally designated by the reference numeral 340. This general designation 340 includes four individual silhouettes, which are individually designated by reference numerals 342, 344, 346, and 348.

The silhouette information is the main “outline image data” that is placed on the reverse side 330 of this sheet of print media 300. Identifying (or identification) data is also to be included, and a “block” of text data is depicted at the reference numeral 350, which states the main identifying “title” of the subject of the image that appears on the front side 310. In the text block 350, the main title is “The Jones Brothers,” and a location and date are also listed in this identifying text block 350. In addition to this text block 350, each of the individual objects of the image data also have an identifying piece of information, and on FIG. 4 it is the names of the four children. For the silhouette object 342, a text identifier 352 lists that child's name as “Mike,” and for the silhouette object 344, a text identifier 354 lists the name of that child as “Tom.” For the silhouette object 346, the text identifying data is listed at 356, as the name “Steve,” and for the silhouette object 348, the identifying text data at 358 is the name “Mark.”

In FIG. 4, the individual text identifiers 352, 354, 356, and 358 are placed at positions that are proximal to the corresponding outlines that make up the individual silhouette objects 342, 344, 346, and 348. This may not always be necessary or desirable, and the present invention will allow the user to specify the location where these individual text identifiers will be positioned on the reverse image side 330 of the sheet media 300. It would, however, be typical for the user to select a proximal position for these text identifiers, either within the image outlines (as in FIG. 4), or perhaps very close to those image outlines, but outside the silhouettes themselves. On the other hand, the user could move the text identifiers to other locations, if desired or necessary for a particular photographic image that is converted into the outline image data, and then the user could add lead lines that essentially will connect the text identifier with (or point to) the correct image object in the silhouette, for example.

As can be seen from inspecting both FIGS. 3 and 4, the general images are essentially the same. The silhouette objects on the reverse side 330 are not depicted as a mirror image of the original image data objects on the front side 310. This means that the individual objects depicted on the front and back sides of the sheet of print media 300 do not line up with one another, if a person was to look “through” the page or sheet, and view both the front images and reverse images through that sheet of print media. While such mirror images on the back side might appear in some conventional photographic prints, this is not a main thrust of the present invention.

It will be understood that the exact shapes and delineations of the silhouette image data for the four overall silhouettes (i.e., the overall silhouette data 340) could be arranged in a very different manner than that depicted on FIG. 4, without departing from the principles of the present invention. In addition, the identifying text data could be quite different, and would not necessarily include the individual names within the head-area of the silhouette data, as was depicted on FIG. 4.Moreover, not every individual silhouette object would necessarily be identified on every reverse-image of a sheet of print media, yet would still fall within the principles of the present invention. Finally, the main “text block” 350 would not necessarily need to be printed on this reverse-side of the sheet of print media 300, and the lack of such a main text block is contemplated by the inventors.

Not every digital image will include persons, but might include other types of objects of interest. For example, a scene of outdoor features, such as mountains or hills could be the main points of interest of an image. Alternatively, other man-made objects could be the important objects within a digital image, including buildings or automobiles, for example. The present invention is not limited to any specific type of object that will be the subject of a digital image, but is mainly interested in having a user be able to generate image data in the form of a silhouette or other type of graphical image that can be back-printed, and which will assist in identifying the objects of the digital image that is printed on the front surface of the same sheet of print media.

The creation of the silhouette (or other form of outline information) that will be generated as image data for the reverse-side of a sheet of print media can be manually controlled by special software, typically resident on a printer, as discussed above. However, such silhouette-generating software could also be resident on a digital camera, a picture phone, or within a personal computer that may be involved with the printer of the present invention. In situations where the special software has difficulty drawing a proper silhouette (or other form of outline) of certain objects in an image, then the special software could provide the user a capability in manually drawing lines or curves to aid in delineating one object from another, for the purposes of back-printing the sheet of print media 300 on FIG. 4.

Alternatively, some digital cameras may have a capability of generating silhouettes using software that is resident on the digital camera itself. Such digital cameras may refer to this silhouette-generating feature as a “Screen Assist” feature, and in that type of digital camera the silhouette would be generated and visible to the user at the digital camera itself. The silhouette may not be in the form of line data such as that depicted on FIG. 4; instead, the silhouette might be all black information to represent the shape of an object, while the background might be all white, for example. In that type of Screen Assist feature, the multiple objects may not be easily delineated. In that situation, human user input will likely be required for a more precise delineation of the objects of interest that are in the digital image data that will be printed on the front surface of a sheet of print media.

It will be understood that various types of image boundary digital processing can be used as a starting step to generate the outline information, when using the present invention. If a digital camera has a Screen Assist-type function, then the “silhouette” that may be generated could be pure black on one portion of the image and pure white on a different portion of the image, rather than the use of thin black lines and curves on a white surface, for example. Alternatively, there may be other types of outline images formed, using different colors for different depths of the objects in a particular digital image, for example. All of this starting data can be gathered and used by the image processing software of the present invention, which will ultimately have a goal of creating line data that will be printed as a dark line on a light surface, in a typical reverse side-printed image for example. Of course, a negative image (e.g., white lines on a dark background) could be generated if desired, but since that would require much more image-forming material (such as toner or ink), the negative-type image is unlikely to be used.

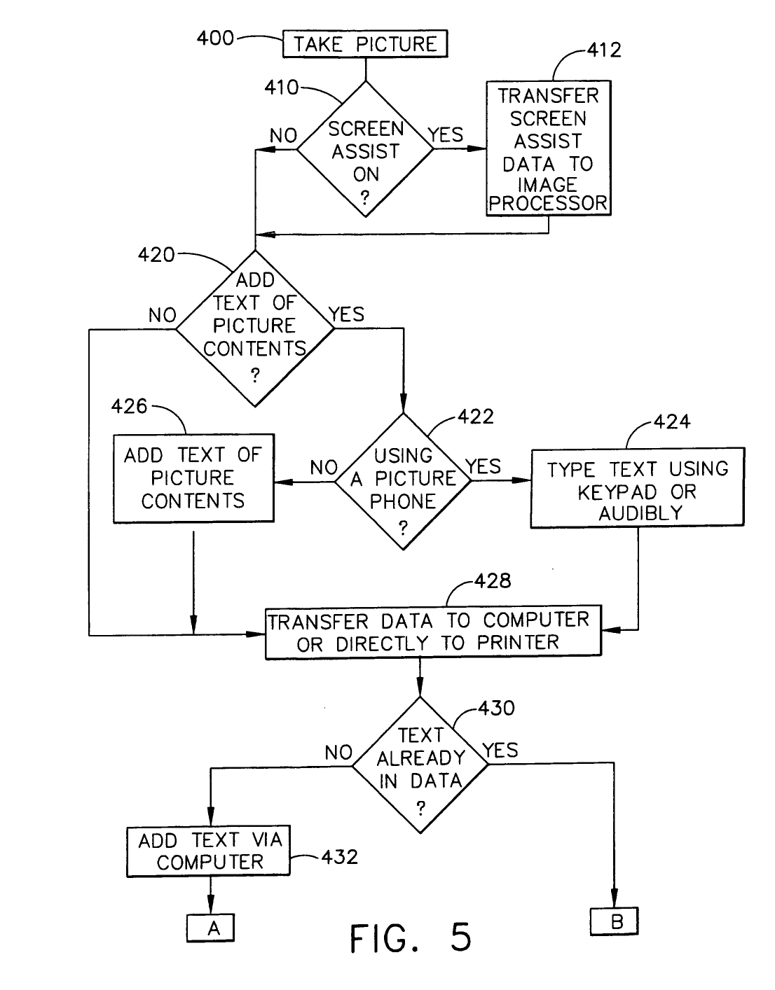

Referring now to FIG. 5, a flow chart for taking a digital image and receiving identifying information about the image is depicted, starting with a step 400 that begins the image-capturing procedure of this flow chart. Once the digital image information has been acquired at the “Take Picture” step 400, the logic flow is directed to a decision step 410 that determines whether or not the “Screen Assist” function is turned on. If not, the logic flow is then directed to a step 420. If the Screen Assist function of the imaging device is turned on, then the logic flow is directed to a step 412 that transfers the Screen Assist data to the image processing device, which will be described below.

Decision step 420 will determine whether or not text information is included along with the image information that was captured by the digital camera. (Note that the digital camera can also be a picture cell phone, or other type of image-acquiring device.) If text data is not to be added to correspond with this digital image data, then the logic flow is directed to a step 428. However, if text is to be added, the logic flow will be directed to a decision step 422 that determines whether or not a picture phone was used as the acquiring device. If the answer is YES, then a step 424 will allow the user to “type” text in using a keypad, or the user can audibly speak into the microphone of the picture phone, and in that way generate text-type data that will be later used on the digital image, according to the present invention. Of course, if the information has been initially entered as sound waves, then that information must either be transcribed into text-type information, or the audio information must be reproduced in a different manner on the sheet of print media. Alternative forms of reproducing audio information is the subject of another patent application that is co-assigned to Lexmark International, Inc. This patent application was filed on Jul. 14, 2003, and is titled, “METHOD AND APPARATUS FOR RECORDING SOUND INFORMATION AND PLAYING SOUND INFORMATION BACK USING AN ALL-IN-ONE PRINTER.”

At step 422, if a picture phone is not being used, then a step 426 will add the text information concerning the picture contents by a means other than an audible input. In general, the user would enter text data by using a keypad, or the text data will be entered later, by use of an external device that did not capture the initial digital image.

At decision block 420, if text is not to be added, then the logic flow is directed to a step 428, which will transfer the image data to another device (such as a computer or a printer). However, if text data is to be included with the image data, then the text data will be part of the overall information that is transferred to another device at step 428, (i.e., both image data and text data are transferred together). Note that, when the image data arrives at a printer, this data becomes a “print job” that will be handled, and printed, by that printer.

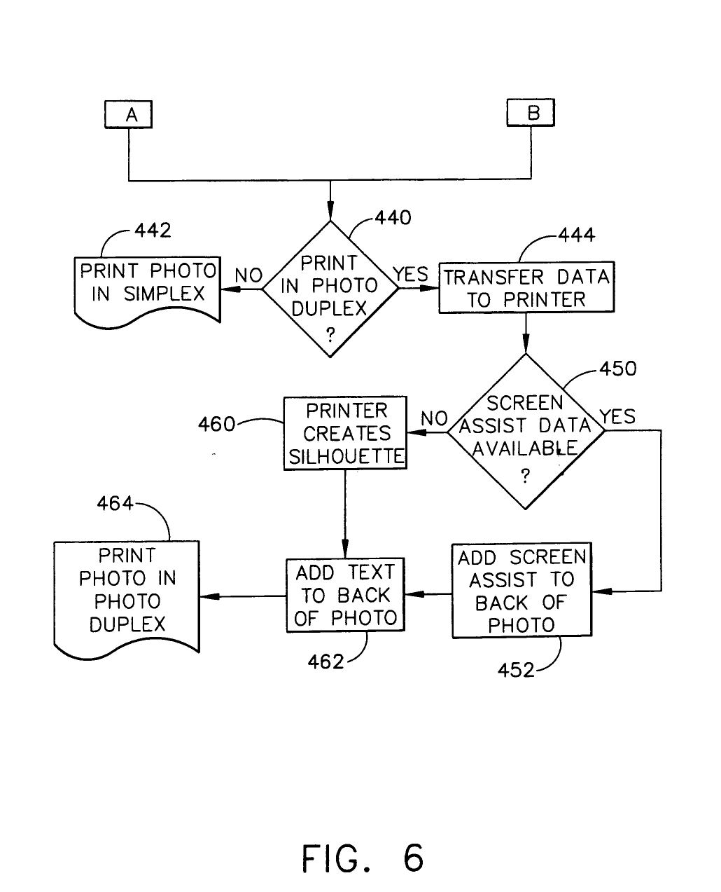

Step 428 will now transfer the data to a computer, or directly to a printer. This refers, for example, to the PC 100 of FIG. 1, or the printer 70 of FIG. 1; or if the hardware configuration is that of FIG. 2, then the image data would be transferred directly to a printer, such as the printer 270. Once the data has been transferred at step 428, a decision step 430 determines whether or not the text information is already included in the data that was received from the image-capturing device. If so, then the logic flow travels to a block “B” that directs the logic flow to FIG. 6. If the text information is not already within the transfer data, then the logic flow is directed to a step 432, in which the text is added by a computer keyboard, or by another computing device with some type of input controls, such as a keypad. This could include the user controls of a printer that has an op-panel, such as the op-panel 290 of the printer 270 depicted in FIG. 2. The logic flow from step 432 is now directed to a block “A” that directs the logic flow to FIG. 6.

Referring now to FIG. 6, the logic flow from both blocks A and B is directed to a decision step 440. This step 440 determines whether or not the printer will operate in a “Photo Duplex” mode, and if so, the print job data will be transferred to a printer, such as the printer 70 of FIG. 1 at a step 444. On the other hand, if data is not to be printed in the Photo Duplex mode, the logic flow will be directed to a step 442, in which the digital image data will be printed in Simplex mode, essentially the same as a standard or conventional printer. At this point, the user could take the printout in the Simplex mode and later decide to print the silhouette-type data, with or without corresponding identification data, on the reverse side of the same sheet of print media. That would require using the Photo Duplex mode of the decision step 440, at a later operation.

Assuming the user was interested in using the Photo Duplex mode at step 440, after the print job data has been transferred to the printer at step 444, a decision step 450 will determine whether or not Screen Assist data was available in the print job data that was transferred to the printer in the first place. If not, then the logic flow is directed to a step 460, and the printer is used to create the image information that will have the form of a silhouette, or other type of outline image for use on the reverse side of the sheet of print media of interest. It should be noted that the printer itself may create the silhouette image data for the reverse side of the sheet of print media, or a personal computer (or other type of external computing device) could be used to assist in this procedure. This would require special software according to the principles of the present invention, both at the printer and at the printer drivers that are installed in the external computing device. However, if an external computing device (i.e., a processing device other than the printer itself) is used to create the silhouette, then the outline data image processing could be performed using the higher-powered processing circuit (e.g., a microprocessor) of the external computing device, rather than using the processing circuit of the printer itself. This is an option that will be addressed by the system designer, and when using the present invention, the designer of the system may determine that only the printer itself will be used to create the silhouette; or that only the PC will be used to create the silhouette, and the resulting outline data will then be transferred to the printer, as needed for printing on the reverse side of the sheet of print media.

Whether the PC or the printer creates the silhouette (outline image) information at step 460, once that silhouette has been generated, it will be incorporated with text information at a step 462. An example of this text information is the identifying information that was depicted on FIG. 4 by the identifying “text block” 350, and the individual identifying information at the reference numerals 352, 354, 356, and 358. In general, it will be desirable for the image information and the identifying information to be combined into one bitmap, so that the reverse side of the sheet of print media will be entirely printed in a single pass through the print engine (or printhead) of the printing device.

At decision step 450, if the Screen Assist data was available in the overall image information that was transferred to the printer at step 444, then this Screen Assist information will be included in the outline information that will be printed on the back or reverse side of the sheet of print media, at a step 452. This Screen Assist data essentially will act as the silhouette data that otherwise would be created or generated at step 460, as described above. Once the silhouette data has been added at step 452 from the Screen Assist information that was transferred to the printer, then the text information will also be added at step 462. As mentioned above, the Screen Assist information, by itself, may not be sufficient to act as the entire amount of outline image data for the user's purposes. For example, the Screen Assist data may only show the uppermost outline data, i.e., along the tops of the heads of the children in FIG. 4. If the user desires to show further outline data (as depicted in FIG. 4), then the user may need to use the printer's (or PC's) special software functions to add that additional outline data.

The final step is to perform the actual printing on the sheet of print media, at a step 464. At this step 464, the sheet of print media will be printed in a Photo Duplex mode, rather than a Simplex mode. In this mode, the front side of the sheet of print media will be printed with the digital image, and then the reverse side of that same sheet of print media will be printed with the outline data and the identification (text) data, that is also referred to herein as the silhouette (or reverse image) information and the identifying information. As described above, if the printing device is capable of automatically performing duplex operations, then there will be no human intervention required to create the two-sided sheet of print media, with its final data printed thereon. On the other hand, as used herein the term “Photo Duplex” will also apply to a printer without a duplexing function, and by use of human intervention the sheet of print media is fed back into the printer for a second print operation. All of these operations and functions are contemplated by the inventors of the present invention.

To summarize the functions of the present invention, digital image information is acquired by a digital imaging device, such as a digital camera or a picture phone. That digital image information can be printed on the front side of a sheet of print media. Certain “custom” information will also be generated and printed on that sheet of print media, however, it will be on the reverse side of this same sheet of media. This custom information will include certain types of image outlines, such as a silhouette of certain objects of the original digital image information. In addition, certain text or other type of identifying information can also be printed on the reverse side, and this information can be positioned at proper locations to correspond to objects depicted in the silhouette (or image outline) information that is also being printed on the reverse side of this sheet of print media. The text data can be printed as sub-titles, for example, or as a “text block” that identifies the overall image, and also can include individual identifying information for individual portions of the silhouette data (or image outline data) printed on the reverse side of this sheet of media.

In addition to the above, the identifying information could be entered as text data, or as audio information via a microphone, for example. The microphone or audio information could be transcribed (using some type of voice transcription software) into text data, and the control software will then allow the user to split the text data into certain sub-titles, if desired, and then to determine a position where that text information will be placed on the reverse side of the sheet of print media. These functions can be accomplished by the control panel or op-panel of the printer, or by using special print drivers that are resident on a personal computer, or other type of external computing device (such as a palm pilot).

While it would be preferred for the reverse-side image information to be automatically generated, if the special software creates a silhouette or other type of image outlines that does not quite correspond to the user's desired shapes, then the special software may include a “manual override” type of function, by which the user can generate portions (or all) of the image outline data that will appear as a silhouette on the reverse side of the sheet of print media. This manual override function could also be used in the instance where Screen Assist data is available from a digital camera, for example, in case the Screen Assist data itself does not generate the type of silhouette that the user desired.

Once the silhouette data (in the form of image outlines) has been determined, the user will then be able to enter, or otherwise use previously acquired, textual information, and then position that textual information to desired locations with respect to the image outlines that appear as a silhouette on the reverse side of the sheet of print media.

It will be understood that the term “print media” herein refers to a sheet or roll of material that has toner or some other “printable” material applied thereto by a print engine, such as that found in a laser printer, or other type of electrophotographic printer. Alternatively, the print media represents a sheet or roll of material that has ink or some other “printable” material applied thereto by a print engine or printhead, such as that found in an ink jet printer, or which is applied by another type of printing apparatus that projects a solid or liquified substance of one or more colors from nozzles or the like onto the sheet or roll of material. Print media is sometimes referred to as “print medium,” and both terms have the same meaning with regard to the present invention, although the term print media is typically used in this patent document. Print media can represent a sheet or roll of plain paper, bond paper, transparent film (often used to make overhead slides, for example), or any other type of printable sheet or roll material. In the present invention, it is typical for the print media to be in the form of a sheet, and both sides (or surfaces) of the sheet will typically have image-forming material (e.g., toner, ink, or wax) placed thereon.

It will also be understood that the logical operations described in relation to the flow charts of FIGS. 5-6 can be implemented using sequential logic, such as by using microprocessor technology, or using a logic state machine, or perhaps by discrete logic; it even could be implemented using parallel processors. One preferred embodiment may use a microprocessor or microcontroller (e.g., the processor 76) to execute software instructions that are stored in memory cells within an ASIC. In fact, the entire microprocessor, along with RAM and executable ROM, may be contained within a single ASIC, in one mode of the present invention. Of course, other types of circuitry could be used to implement these logical operations depicted in the drawings without departing from the principles of the present invention.

It will be further understood that the precise logical operations depicted in the flow charts of FIGS. 5-6 and discussed above, could be somewhat modified to perform similar, although not exact, functions without departing from the principles of the present invention. The exact nature of some of the decision steps and other commands in these flow charts are directed toward specific future models of printer systems (those involving Lexmark printers, for example) and certainly similar, but somewhat different, steps would be taken for use with other models or brands of printing systems in many instances, with the overall inventive results being the same.

As used herein, the term “proximal” can have a meaning of closely positioning one physical object with a second physical object, such that the two objects are perhaps adjacent to one another, although it is not necessarily required that there be no third object positioned therebetween. In the present invention, the first “physical object” can merely be a silhouette of a person or other type of object that appeared in the image data that is to be printed on the front side of a sheet of print media; the second “physical object” can merely be one or more alphanumeric characters that comprise identification data, such as text information which refers to that silhouetted person (or other type of object). There may be instances in which the identification data is positioned within the silhouetted object, and there may be instances in which the identification data is position “outside” the silhouetted object. Moreover, if the image data contains many objects of interest, the silhouetted objects may be too small in size and too closely spaced for the identification data to always be positioned at a location that is literally “proximal,” and in this situation, the identification data (ID data) might be positioned at a non-proximal location with some type of lead line that connects (or points to) the corresponding object, from the ID data.

All documents cited in the Detailed Description of the Invention are, in relevant part, incorporated herein by reference; the citation of any document is not to be construed as an admission that it is prior art with respect to the present invention.

The foregoing description of a preferred embodiment of the invention has been presented for purposes of illustration and description. It is not intended to be exhaustive or to limit the invention to the precise form disclosed. Any examples described or illustrated herein are intended as non-limiting examples, and many modifications or variations of the examples, or of the preferred embodiment(s), are possible in light of the above teachings, without departing from the spirit and scope of the present invention. The embodiment(s) was chosen and described in order to illustrate the principles of the invention and its practical application to thereby enable one of ordinary skill in the art to utilize the invention in various embodiments and with various modifications as are suited to particular uses contemplated. It is intended to cover in the appended claims all such changes and modifications that are within the scope of this invention.

The invention claimed is:

1. A method for controlling a printing apparatus, said method comprising:
receiving a print job from an external device, said print job containing digital image data;
configuring at least a portion of said digital image data as front-side image data, and printing said front-side image data on a first surface of a sheet of print media;
determining outline image information from said front-side image data;
determining identification information that corresponds to at least a portion of said outline image information;
determining at least one position where said identification information is to be located with respect to said outline image information; and
configuring both said outline image information and said identification information as reverse-side image data, and printing said reverse-side image data on a second, opposite surface of said sheet of print media.

2. The method as recited in claim 1, wherein said digital image data comprises a photograph acquired by an array of optical sensing elements.

3. The method as recited in claim 2, wherein said array of optical sensing elements are part of a digital camera, or are part of a picture telephone.

4. The method as recited in claim 1, wherein said outline information comprises at least one set of pixel information that represents an outline of at least one object that appears in said front-side image data.

5. The method as recited in claim 4, wherein said outline information forms a line image that, when viewed from said second surface, is a representation of said front-side image data when viewed from said first surface,and is not a mirror image of said front-side image data.

6. The method as recited in claim 4, wherein said outline of the at least one object has the appearance of a silhouette of said of at least one object.

7. The method as recited in claim 1, wherein said identification information comprises at least one of: (a) alphanumeric characters, and (b) audio data.

8. The method as recited in claim 7, wherein said step of determining at least one position where said identification information is to be located comprises placing at least one alphanumeric character proximal to an outline of at least one object that is including in said outline information.

9. The method as recited in claim 1, wherein said step of printing both said outline image information and said identification information on the second surface of said sheet of print media occurs in a single pass through a printing station.

10. The method as recited in claim 1, wherein said steps of determining outline image information from said front-side image data, determining identification information that corresponds to said outline image information, and determining at least one position where said identification information is to be located with respect to said outline image information occur at one of:
(a) a processing circuit within said printing apparatus;
(b) an external computer that is in communication with said printing apparatus;
(c) a digital camera that is in communication with said printing apparatus;
(d) a picture telephone that is in communication with said printing apparatus;
(e) a digital camera that is in communication with an external computer, wherein said external computer is in communication with said printing apparatus; and
(f) a picture telephone that is in communication with an external computer, wherein said external computer is in communication with said printing apparatus.

11. A printing apparatus, comprising:
an input/output circuit; an interface circuit; and a printing station that applies image-forming material to a sheet of print media; wherein:
said input/output circuit receives a print job that contains digital image data;
said interface circuit contains input and output devices that are configured to move a sheet of print media to said printing station and, according to said digital image data, to apply said image-forming material to a first surface of said sheet of print media;
said input/output circuit receives outline image information that is based on said digital image data;
said input/output circuit receives identification information that corresponds to said outline image information, and which determines at least one position where said identification information is to be located with respect to said outline image information; and
said interface circuit is further configured to move said sheet of print media to said printing station a second time and, according to said outline image information and said identification information, to apply said image-forming material to a second, opposite surface of said sheet of print media.

12. The printing apparatus as recited in claim 11, further comprising one of: (a) a digital camera; and (b) a picture telephone; and (c) a video camera that is capable of converting video data into a still image comprised of digital pixels;
wherein said digital image data comprises a photograph acquired by one of (a), (b), and (c).

13. The printing apparatus as recited in claim 11, further comprising a processing circuit that controls signals to and from said interface circuit, and a memory circuit that stores data used by said processing circuit; and
wherein said processing circuit is physically located at one of: (a) said printing apparatus, and (b) a separate computing apparatus.

14. The printing apparatus as recited in claim 11, wherein: after said image-forming material has been applied to the first surface of said sheet of print media by said printing station, said sheet of print media is directed to an output area, and by way of human intervention, is then placed upside-down at an input area, then said sheet of print media is again directed to said printing station and has further of said image-forming material applied to the second, opposite surface of said sheet of print media.

15. The printing apparatus as recited in claim 11, further comprising a duplexer station that automatically flips said sheet of print media after said image-forming material has been applied to the first surface of said sheet of print media by said printing station, and before said sheet of print media is again directed to said printing station and has further of said image-forming material applied to the second, opposite surface of said sheet of print media.

16. The printing apparatus as recited in claim 11, further comprising an external image processing device, said external image processing device being contained in one of:
(a) a computer that is in communication with said printing apparatus;
(b) a digital camera that is in communication with said printing apparatus;
(c) a picture telephone that is in communication with said printing apparatus;
wherein said external image processing device is configured to: (d1) determine outline image information from said front-side image data, (d2) determine identification information that corresponds to said outline image information, and (d3) determine at least one position where said identification information is to be located with respect to said outline image information.

17. The printing apparatus as recited in claim 11, further comprising at least one external image processing device, said at least one external image processing device being contained in at least one of:
(a) a computer that is in communication with said printing apparatus;
(b) a digital camera that is in communication with one of said printing apparatus and said external computer;
(c) a picture telephone that is in communication with one of said printing apparatus and said external computer;
wherein said at least one external image processing device is configured to: (d1) determine outline image information from said front-side image data, (d2) determine identification information that corresponds to said outline image information, and (d3) determine at least one position where said identification information is to be located with respect to said outline image information.

18. The printing apparatus as recited in claim 11, wherein said outline information comprises at least one set of pixel information that represents an outline of at least one object that appears in said digital image data.

19. The printing apparatus as recited in claim 18, wherein said outline information forms a line image that, when viewed from said second surface, is a representation of said digital image data when viewed from said first surface, and is not a mirror image of said digital image data.

20. The printing apparatus as recited in claim 18, wherein said outline of the at least one object has the appearance of a silhouette of said of at least one object.

21. The printing apparatus as recited in claim 18, wherein said identification information comprises at least one of: (a) alphanumeric characters, and (b) audio data.

22. A printing apparatus, comprising:
an input/output circuit; an interface circuit; a processing circuit that controls signals to and from said interface circuit; a memory circuit that stores data used by said processing circuit; and a printing station that applies image-forming material to a sheet of print media;
wherein:
(a) said input/output circuit receives a print job that contains digital image data;
(b) said interface circuit contains input and output devices that are configured to move a sheet of print media to said printing station and, according to said digital image data, to apply said image-forming material to a first surface of said sheet of print media;
(c) said processing circuit is configured to:
(i) determine outline image information that is based on said digital image data;
(ii) determine identification information that corresponds to said outline image information; and
(iii) determine at least one position where said identification information is to be located with respect to said outline image information; and
(d) said interface circuit is further configured to move said sheet of print media to said printing station a second time and, according to said outline image information and said identification information, to apply said image-forming material to a second, opposite surface of said sheet of print media.

23. The printing apparatus as recited in claim 22, wherein: after said image-forming material has been applied to the first surface of said sheet of print media by said printing station, said sheet of print media is directed to an output area, and by way of human intervention, is then placed upside-down at an input area, then said sheet of print media is again directed to said printing station and has further of said image-forming material applied to the second, opposite surface of said sheet of print media.

24. The printing apparatus as recited in claim 22, further comprising a duplexer station that automatically flips said sheet of print media after said image-forming material has been applied to the first surface of said sheet of print media by said printing station, and before said sheet of print media is again directed to said printing station and has further of said image-forming material applied to the second, opposite surface of said sheet of print media.

25. The printing apparatus as recited in claim 22, further comprising one of: (a) a digital camera; and (b) a picture telephone; and (c) a video camera that is capable of converting video data into a still image comprised of digital pixels;
wherein said digital image data comprises a photograph acquired by one of (a), (b), and (c).

26. The printing apparatus as recited in claim 22, wherein said outline information comprises at least one set of pixel information that represents an outline of at least one object that appears in said digital image data.

27. The printing apparatus as recited in claim 26, wherein said outline information forms a line image that, when viewed from said second surface, is a representation of said digital image data when viewed from said first surface, and is not a mirror image of said digital image data.

28. The printing apparatus as recited in claim 26, wherein said outline of the at least one object has the appearance of a silhouette of said of at least one object.

29. The printing apparatus as recited in claim 22, wherein said identification information comprises at least one of: (a) alphanumeric characters, and (b) audio data.
